(19) United States
(12) Patent Application Publication
(10) Pub. No.: US 2016/0040639 A1
(43) Pub. Date: Feb. 11, 2016

(54) CYCLONIC FUEL FILTER AND SYSTEM

(71) Applicant: United Components, Inc., Lake Forest, IL (US)

(72) Inventors: Daniel J. McCarthy, Troy, MI (US); Michael R. Donoghue, Milford, OH (US); Alexander Munro, Windsor (CA)

(21) Appl. No.: 14/817,715

(22) Filed: Aug. 4, 2015

Related U.S. Application Data
(60) Provisional application No. 62/033,536, filed on Aug. 5, 2014.

(51) Int. Cl. F02M 37/22; F02M 37/00; B04C 9/00; B01D 21/26; B01D 35/00

(52) U.S. Cl. CPC F02M 37/22; B01D 21/267; B01D 35/005; B04C 9/00; F02M 37/0076; B04C 2009/004

(57) ABSTRACT

A method and apparatus for filtering fuel in a motor vehicle includes a cyclonic fuel filter, the cyclonic filter including a housing having a body forming a cyclone chamber defined by walls of the body. The body includes an inlet to receive fuel and an outlet to transport fuel away from the cyclonic fuel filter after it has been processed. The cyclonic fuel filter further includes a receptacle to receive particulates filtered from the fuel. Fuel introduced into the inlet, travels along the inner wall in a cyclical circular pattern, subjecting it to centrifugal forces as it rotates. The centrifugal forces cause heavier particulates to travel outward against the walls of the cyclonic fuel filter, and the force of gravity causes those particulates to move down the wall to be received within the receptacle at the bottom of the cyclonic filter. Filtered fuel exits through an outlet at the top of the body of the cyclonic filter.

### CROSS-REFERENCE

This application claims the benefit of priority under 35 U.S.C. §119(e) to U.S. Provisional Patent Application No. 62/033,536, filed on Aug. 5, 2014, the entire disclosure of which is incorporated herein.

### BACKGROUND

1. Field of the Disclosure

The present invention relates generally to a fluid filter assembly and, more particularly, to a fuel filter assembly.

2. Background of the Disclosure

In the automotive industry, it is known to use a fuel filter assembly to filter fuel pumped from a fuel tank before it is introduced into an engine. Typical fuel filter assemblies are known to have a filter media (e.g. filtration paper or material) through which the fuel passes. The typical filter media is configured to capture and retain debris or particles in the fuel before the fuel passes to the engine. Given the nature of such a filtration process, overtime the filter media may have a reduced fluid flow, or become clogged due to the debris retained on the filter media, rendering the fuel system ineffective or inoperable.

A fuel filter assembly (or a portion of a fuel filter assembly) may be located inside or outside of the fuel tank of the vehicle. For instance, a fuel tank typically includes a fuel sending unit that contains a fuel pump to pump fuel from the tank to the engine. The fuel sending unit may also include a filter that filters fuel before it is introduced into the engine. In addition or alternatively, a separate fuel filter may be positioned along the fuel flow path between the fuel tank and the engine. Filters inside the fuel sending unit or along the fuel flow path may include filtration media that can become clogged, leading to poor performance. This is especially true as the age of the fuel tank increases, as the amount of contaminants or foreign particulates within the fuel tank will increase over time. The foreign particulates are picked up by the fuel while it is retained in the fuel tank. When a filter inside the fuel sending unit is partially clogged, the reduced flow may affect the fuel pump, leading to premature pump failure.

When a fuel filter is included in a fuel sending unit in a fuel tank, the fuel filter may be in the form of a sock filter or other similar filter that is positioned at the inlet port of the fuel sending unit. Fuel that is pumped from the fuel tank into the sending unit by the fuel pump is passed through the sock filter. Sock filters are known to collect the particulates and larger particles of contaminates carried by the fuel from the fuel tank, and may become ineffective over time given the build-up of particulates in the tank.

### SUMMARY

According to the present disclosure, a fuel filter assembly is configured to filter and remove particulates from fuel for a motor vehicle. The fuel filter assembly includes a fuel filter positioned within a fuel sending unit to remove particulates from the fuel system prior to the fuel being used in the engine of the vehicle.

In illustrative embodiments, the fuel filter includes a housing having a body forming a cyclone separator defined by an inner wall of the body, the body including an inlet to receive fuel and an outlet to transport fuel away from the fuel filter after it has been processed. The fuel filter further includes a receptacle to receive particulates separated from the fuel, the receptacle located within the cyclone separator. The cyclone separator is circumferential about a first axis, and the inlet is tangential to the first axis to cause fuel flowing into the cyclone separator to flow along the wall of the body. As fuel is introduced into the inlet, it travels along the wall in a helical pattern, subjecting it to centrifugal forces as it rotates to cause vortex separation. The centrifugal forces cause heavier particulates in the lighter fuel to separate out and the force of gravity causes those particulates to slide down the wall to be received within the receptacle at the bottom of the cyclonic filter. Filtered fuel exits through an outlet at the top of the body of the cyclonic filter.

In illustrative embodiments, the speed and direction of the fuel as it enters the cyclone chamber causes the fuel to take a first path of travel helically around the wall of the body of the cyclonic filter. The first path of travel is rotationally along the wall to create an outer vortex of fluid flow. The centrifugal forces applied to the fuel as it rotates around the cyclone chamber causes particulates in the fuel to be driven outward from the center of the rotational axis, causing the particulates to collide with the wall. The particulates then slide down the wall to the receptacle for storage.

In illustrative embodiments, the wall of the body of the cyclonic separator is conical and gradually decreases in diameter from an upper section of the cyclonic separator to a lower section of the cyclonic separator. As fuel travels from the upper section to the lower section in a rotational movement along the wall, the fuel changes flow path direction and speed due to the change in diameter of the wall the fluid is traveling along. These changes cause the filtered fuel to form a second inner vortex that rotates in the same direction as the first outer vortex in a direction toward the top of the cyclonic filter. The filtered fuel is directed toward an outlet at the top of the cyclonic filter to be transported to the fuel pump.

In illustrative embodiments, the cyclonic fuel filter is positioned within a fuel reservoir configured to retain fuel for use in a vehicle engine. The fuel reservoir may include at least an annular wall defining a fuel storage chamber and a base, and the inlet of the cyclonic fuel filter may be integrally formed with the base of the fuel reservoir. The fuel reservoir is configured to fit within a fuel tank to transport fuel from the fuel tank to the cyclonic filter through the inlet formed in the base of the fuel reservoir. The storage chamber of the fuel reservoir is configured to retain fuel after it has been filtered through the cyclonic filter. In illustrative embodiments, the fuel reservoir may be configured to retain a specific amount of reserved, filtered fuel within the reservoir, the reserved fuel being retained to ensure sufficient amount of fuel supply for the vehicle when the fuel level in the fuel tank is low to prevent fuel starvation during a hard stop or turn.

In illustrative embodiments, a fuel pump is positioned within the fuel reservoir. The fuel pump may be connected to the outlet of the cyclonic filter to receive fuel after it has been filtered in the cyclonic filter. The fuel pump may be configured to pump fuel received from the cyclonic filter into the storage chamber of the fuel reservoir. The fuel pump may be connected to the cyclonic separator via a closed passageway. When the fuel pump creates a vacuum force within the closed passageway, fuel from the fuel tank is driven by vacuum force into the inlet of the cyclonic filter. The vacuum of the fuel pump accordingly directly affects the force and speed of fuel traveling through the cyclonic filter. The direction, force and speed of the fuel as it enters the cyclone chamber of the cyclonic filter cause the fuel to rotate around the inner walls to form a vortex.

Other systems, methods, features and advantages of the invention will be or will become apparent to one of skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 is a partial cross-sectional view of a fuel system for a vehicle, showing a cross-sectional view of a fuel reservoir, the fuel reservoir including a peripheral wall defining a space within the fuel reservoir, the fuel system further comprising a cyclonic filter positioned within the space, the cyclonic filter having an intake port that extends outside of the reservoir to permit fuel to enter the cyclonic filter.

FIG. 2 view is similar to FIG. 1, showing a fuel pump positioned within the space of the fuel reservoir, the fuel pump being connected to an outlet of the cyclonic filter to receive fuel from the cyclonic filter, the fuel pump further being configured to pump fuel out of the fuel reservoir via an outlet tube of the fuel pump.

FIG. 3 is a sectional view of the cyclonic filter of FIG. 1, showing a cyclone chamber, an intake port and a passageway leading form the intake port into the cyclonic chamber, an outlet passageway at the top leading away from the cyclone chamber, and a particulate storage chamber located adjacent the bottom of the cyclone chamber.

FIG. 4 is a cross-sectional view taken along lines 4-4 of FIG. 5.

FIG. 5 is a side perspective view of the cyclonic filter.

FIG. 6 is a cross-sectional view of an illustrative embodiment of the cyclonic filter of FIG. 1, showing the flow of filtered fuel through the cyclonic filter.

FIG. 7 is a perspective view of the cyclonic filter.

FIG. 8 is diagrammatic view of the fuel system of FIG. 1, illustrating the flow of fuel through the fuel reservoir, and specifically showing the fuel first flows into the cyclonic filter through an inlet port, then flows through the cyclonic filter, then flows through the exit port into the fuel pump, then flows from the fuel pump into the fuel reservoir.

FIG. 9 is a perspective view of the cyclonic filter in phantom, further illustrating fuel flow through the cyclonic filter at various points along the length of the filter, the cross-sectional representations showing velocity vectors of moving fuel through the cyclonic filter.

Other aspects and advantages of the present invention will become apparent upon consideration of the following detailed description, wherein similar structures have like or similar reference numerals.

### DETAILED DESCRIPTION

The present disclosure is directed to a filter assembly for fuel, and more particularly, to a cyclonic fuel filter to remove particulates or debris from fuel systems of motor vehicles. While the present disclosure may be embodied in many different forms, any specific embodiment(s) discussed herein is with the understanding that the present disclosure is to be considered only as an exemplification of the principles of the disclosure, and it is not intended to limit the disclosure to the embodiment illustrated.

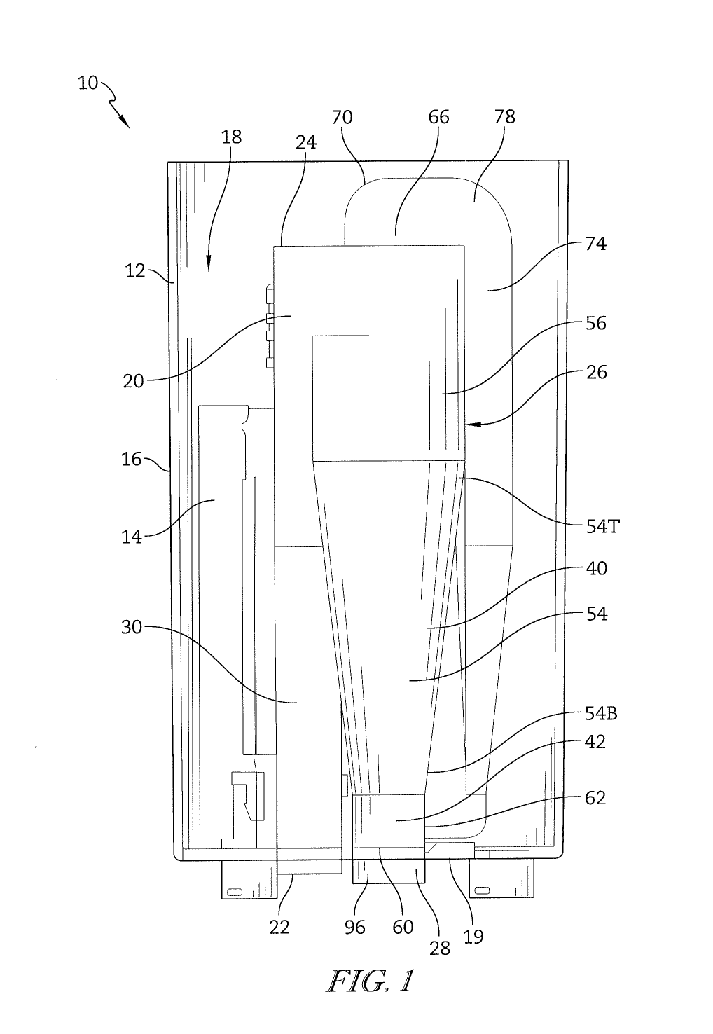

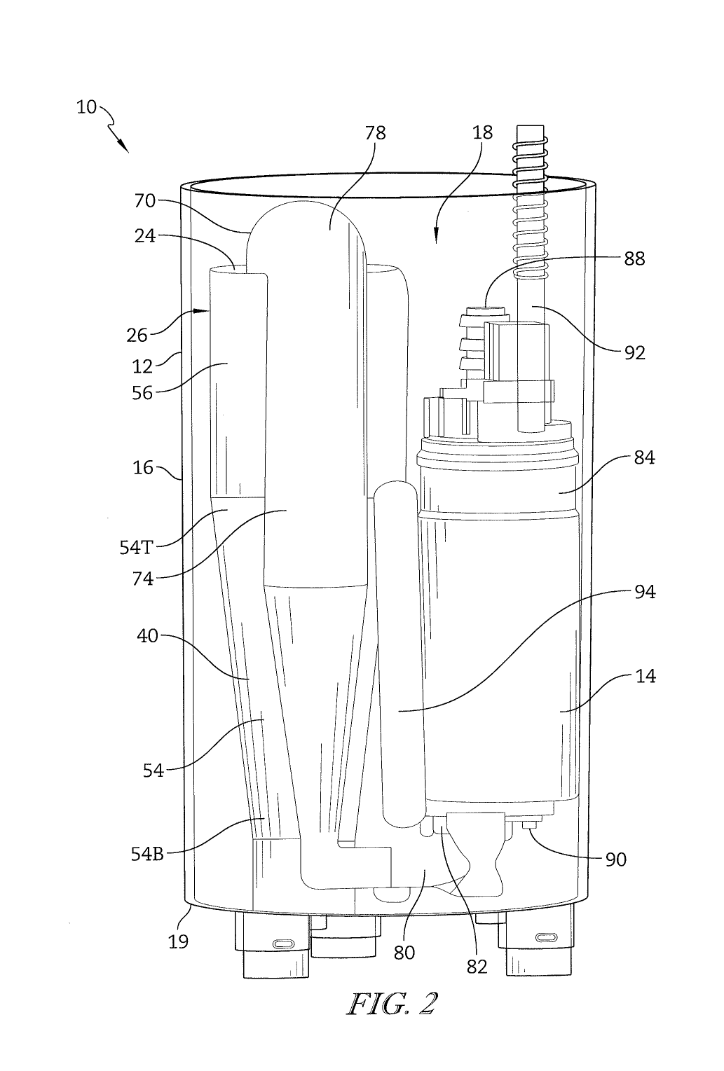

Referring to FIGS. 1 and 2, an illustrative embodiment of a fuel sending unit 10 is depicted which generally includes a fuel reservoir 12, a cyclonic filter assembly 20, and a fuel pump 14. In illustrative embodiments, the cyclonic filter assembly 20 and fuel pump 14 are positioned within a space 18 of the fuel reservoir 12 and are substantially contained within the fuel reservoir 12. Portions of the cyclonic filter assembly 20 and fuel pump 14 may be integrally formed with the reservoir 14. The fuel system 10 may be configured to be received within a fuel tank (not shown) of a motor vehicle.

In illustrative embodiments, the reservoir 12 generally has a cylindrical sidewall 16 that defines the space 18 within the fuel reservoir 12. The reservoir 12 may further include a bottom end cap 19 that extends between sidewall 16. The fuel reservoir 12 may be cylindrical in nature and be may be configured to be fully or partially received within the larger fuel tank of a vehicle. In illustrative embodiments, the housing 16 and bottom end cap 19 are configured to retain fule to be used by fuel pump 14. Fuel reservoir 12 may optionally include a cover 21 to prevent fuel from inside the reservoir from flowing out the top of the fuel reservoir 12. Various other embodiments of the fuel reservoir 12 are encompassed in the present disclosure.

Sending unit 10 is configured to draw fuel from the fuel tank and transfer the fuel to the engine. Generally, fuel is pumped from the fuel tank into the cyclonic filter 20 to filter contaminates or other particles from the fuel, and then is pumped through the fuel pump 14 into the fuel reservoir 12. Fuel is then pumped from the reservoir 12 to a fuel passageway (not shown) by the fuel pump 14 to the vehicle's engine for combustion.

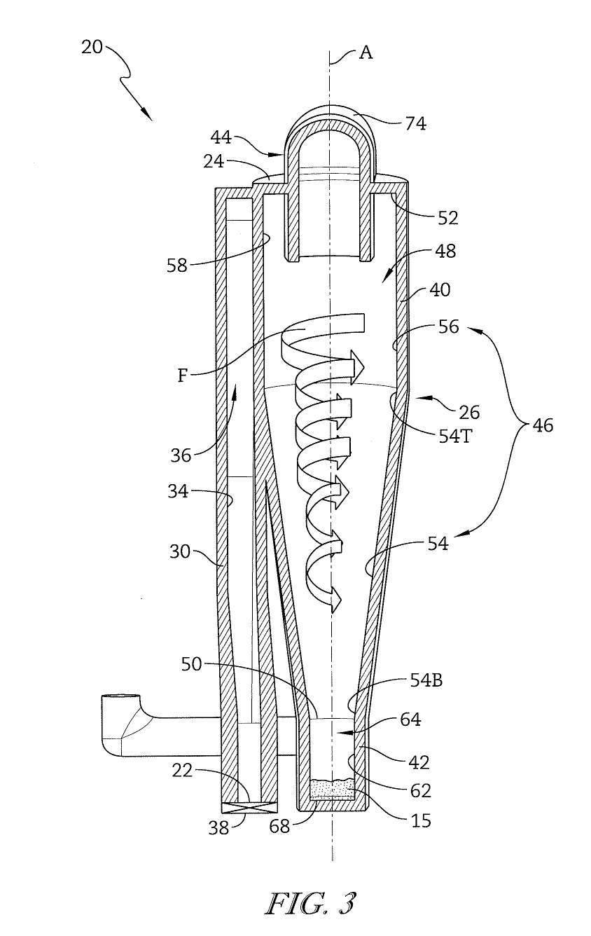

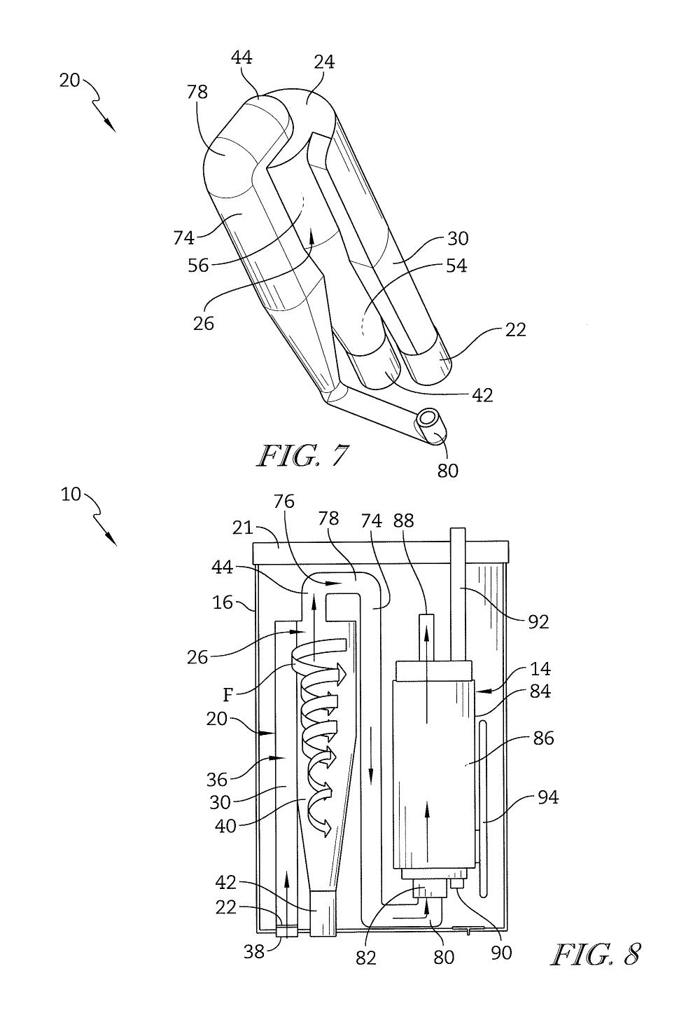

As illustrated in FIGS. 3-7, cyclonic filter 20 includes an inlet port 22 to receive fuel, a cyclone separator 26 that processes fuel received into the cyclonic filter 20, and an outlet 44 that transports fuel that has been processed in the cyclonic filter 20 to fuel pump 14. Inlet port 22 is connected to the cyclone separator 26 by an inlet passageway 30, as illustrated in FIG. 3. Inlet passageway 30 to the cyclone chamber 26. In illustrative embodiments, the inlet passageway 30 may include a circular inner wall 34 that defines a flow channel 36 for fuel to flow through. The inlet port 22 may be located adjacent a bottom wall 28 of the cyclonic filter 20 and the inlet passageway 30 may extend vertically upward from the inlet port 22 to an inlet opening 32 of the cyclone separator 26, as discussed below. Depending on the configuration of the fuel system 10, the inlet passageway 30 may vary in diameter or shape from the inlet port 22 to the inlet opening 32. The inlet port 22 may be positioned to receive fuel from the fuel tank that is outside the fuel reservoir 12. In illustrative embodiments, the inlet port 22 may be integrally molded with the bottom end cap 19 or sidewall 16 of the reservoir 12. The inlet port 22 may optionally comprise a pressure relief valve 38 or other similar valve that can control or restrict the flow of fuel into the inlet passageway 30.

Cyclone sepearator 26 includes, a body 40, inlet opening 32 to receive fuel adjacent body 40, a particulate storage chamber 42 to retain particulates or sediment 15 filtered from the fuel in body 40, and the outlet 44 to transport fuel out of the body 40. Cyclone chamber 26 is configured to transport fuel into the body 40 via the inlet opening 32. The fuel travels is a spiral motion around the conical-shaped body causing a centrifugal force to be applied to the fuel in a direction radially outward of the flow path F. In illustrative embodiments, the centrifugal force causes solid particulates or contaminants in the fuel to separate from the fuel.

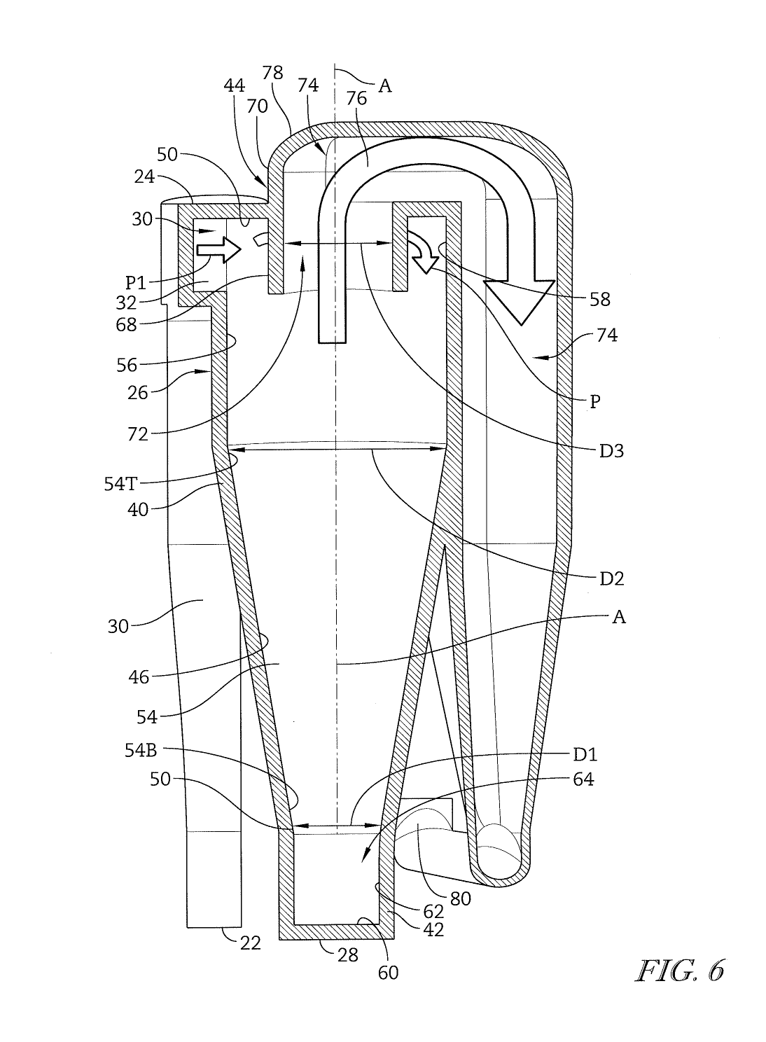

As illustrated in FIGS. 3 and 6, the body 40 of the cyclone chamber 26 includes a wall 46 that defines a processing chamber 48 in which fuel may flow in a spiral manner, a described below. In illustrative embodiments, wall 46 may extend from a lower end of the body 40 to an upper end 52 of the body 40, and includes a cone-shaped portion 54 and a cylindrical portion 56. In illustrative embodiments, the cone-shaped portion 54 may include a bottom section 54B of the annular wall 46 with a first diameter D1 and top section 54T with a second diameter D2. The cylindrical portion 56 of the annular wall 46 may have a diameter similar to the top section 54T, such as diameter D2. The diameter D1 of the bottom section 54B is smaller in size than the diameter D2 of the top section 54T, as illustrated in FIG. 6, for example. In illustrative embodiments, a top wall 24 is provided on top of the cylindrical portion 56. Together with the particulate storage chamber 42, the top wall 24 and wall 46 are configured to enclose the processing chamber 48.

Inlet opening 32 is formed in cylindrical portion 56 of the annular wall 46 to connect the inlet passageway 30 with the body 40. Inlet opening 32 may be positioned such that the flow of fluid from the inlet opening is tangential to the axis A of rotation of fuel around body 40. For instance, the inlet flow path P1 may be located in an inner surface 58 of the cylindrical portion 56 and be tangential to the axis A upon which the inner surface 58 is based. In light of the location of the inlet opening 32, as fuel enters the body 40 from the inlet opening 32, it is directed to travel in a spiral path P along the wall 46, as illustrated in FIG. 6. Tubular wall 68 causes fuel coming in inlet passageway 30 to encournter cylindrial portion 56 to prevent short circuiting out excit opening 72. As the fuel travels in the spiral path P, the centrifugal force is naturally applied to the fuel. The flow speed of the fuel causes the fuel to continue to travel along the flow path F along the wall 46 while the centrifugal force is applied to the fuel, as illustrated in FIG. 3. As the body 40 is conical in shape, rotation of the fuel increases as the fluid flows around the radial wall 46. The centrifugal force causes particulates and contaminants in the fuel to be transported radially outward such that such particulates abut against and may be maintained against the wall 46 by the centrifugal force F. In illustrative embodiments, the wall 46 is conical in shape with decreasing radius from the upper end 52 to the lower end 50. Accordingly, particulates that have abutted against the wall 46 travel down the wall 46 toward the particulate storage chamber 42.

In illustrative embodiments, fuel flow rate, cyclonic chamber size, and cyclonic chamber diameter (and rate or angle of change of diameter) of the conical-shaped body, and other factors such as viscosity, may determine the separation efficiency for various particulates sizes and fuel mixtures. For instance, a higher concentrated fuel may require a higher flow rate in order to separate contaminates from the fuel. Higher flow rate can improve the collection efficiency of the cyclonic filter 20, but at the expense of an increased pressure drop. The term hydrocyclone is typically used to describe fluid-based cyclonic separators. In such separators, contaminated fluid enters a circular barrel via a tangential inlet. This creates a centrifugal flow around the diameter of the cylinder, and gravitational forces cause the fluid flow to travel downward toward the bottom of the separator as it cycles around the diameter of the cylinder. When the fluid flow reaches a conical portion of the separator 26, the velocity of the fluid flow naturally increases. As the fluid continues to flow into the separator 26, larger particles are transported to the wall and eventually travel down to a first exit port adjacent the apex of the conical portion (e.g. underflow). This is sometimes referred to as the outer vortex, and it causes larger particles to collide with the wall and collect at the bottom (underflow) area. Due to the increased speed and shape of the conical portion, the remaining fluid and remaining particulates in the fluid change flow direction to flow toward the larger end of the conical portion. This is sometimes referred to as the inner vortex, and the cleaned fluid swirls into the inner vortex to exit out of the top (overflow) area. The flow from the inner vortex may exit the separator via a second exit port (e.g. tube) that extends slightly into the body of the separator. The first and second exit ports are aligned around the axis of the separator that defines the conical shape.

FIG. 9 illustrates a representation of fluid flow path of fuel in the cyclonic filter 20. As illustrated in the cross-sectional views taken at two different planes B and C along the axis A of the cyclonic filter, twin cyclones of fluid, an outer cyclone 100 and an inner cyclone 102, cycle around the internal space of the cyclonic filter 20. The outer cyclone 100 cycles around the cyclonic filter adjacent the wall 46 of the cyclonic filter 20, and carries particulates or debris that is undesirable in the fuel, and the cyclonic movement separates those particulates from the fuel so that they slide down the surface of the wall 46. The outer cyclone 100 has fluid flow directed towards the bottom of the cyclonic filter. As the fluid continues to flow around the radial wall 46, the pull of gravity will cause such downward movement. As the fluid flow gets closer to the bottom of the cyclonic filter, the radius of the radial wall decreases, causing the speed and direction of the fluid flow to change. Specifically, the fluid flow eventually gets to a point in the cyclonic filter where the fluid flow changes direction and travels upward toward the top of the cyclonic filter due to the radius, curvature, and speed of flow at a point along the cyclonic filter's inner radial wall. As illustrated in the cross-sectional views, this produces the inner cyclone 102 that rotates in the same direction as the outer cyclone 100. The radius of the outer cyclone 100 is substantially defined by the radial wall 46 of the cyclonic filter.

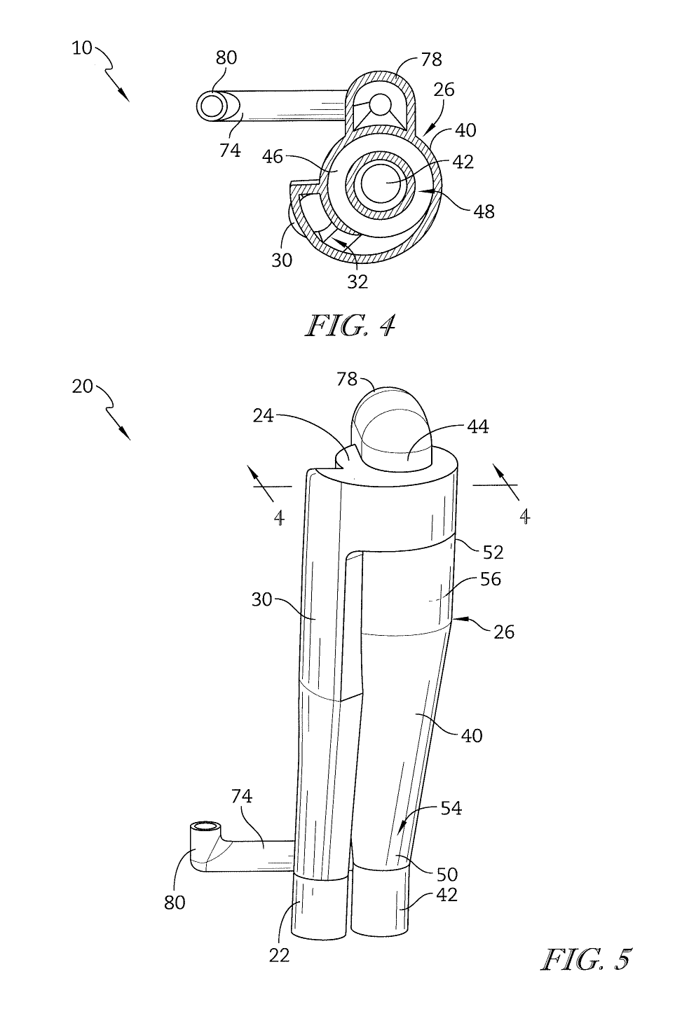

Particulate storage chamber 42 is coupled to the lower end 50 of the body 40, as illustrated in FIGS. 3-6. The particulate storage chamber 42 includes a bottom wall 60 and an annular side wall 62, the annular side wall forming an opening 64 into the particulate storage chamber 42 to permit particulates and contaminants to enter the particulate storage chamber 42 from the cone-shaped portion 54 of the cyclone chamber 26. In illustrative embodiments, the opening 64 is of the same diameter D1 as the bottom section 54B of the cone-shaped portion 54. In illustrative embodiments, the particulate storage chamber 42 collects particulates and contaminants separated from the fuel as it is processed in the cyclone separator 26. The size and shape of the particulate storage chamber 42 may be varied depending on the expected life-cycle of the cyclonic filter 20. As illustrated in FIGS. 3-4, the particulate storage chamber may be symmetrical about the axis A of the cyclonic filter 20. The particulate storage chamber 42 may optionally include a removable cap 96 along the bottom wall 60 to permit removal of particulates collected in the storage chamber 42 shown in FIG. 1.

Outlet 44 of the cyclone chamber 26 may be configured to extend through the top wall 24, as illustrated in FIGS. 3, 6, and 8. Illustratively, the outlet 44 may comprise a circumferential outlet tube 66 that is symmetrical about the axis A of the cyclonic filter 20 and defines an outlet flow path 76. The outlet tube 66 may include an tubular wall 68 that extends into the processing chamber 48 of the cyclonic filter 20 and an exterior portion 70 that is outside of the cyclonic filter 20 within the space 18 of the reservoir 12. The exterior portion 70 connects to an outflow passageway 74 to transport fuel away from the cyclonic filter 20 to the fuel pump 14. Exit passageway tubular wall 68includes an opening 72 into the processing chamber 48 to receive filtered fuel after it is processed in the cyclone separator 26. The fuel is then transported through the outlet flow path 76 to the outflow passageway 74, and then ultimately to the fuel pump 14. The diameter D3 of the inner portion 68 of the outlet tube 66 may be sized to be equal to or larger than the diameter D2 of the bottom portion 54B of the cone-shaped portion 54 of the inner annular wall 46. In illustrative embodiments, the diameter D3 of the inner portion 68 may be related to the degree of slope of the inner radial wall 46 and/or the diameter D2 of the bottom portion 54B.

In illustrative embodiments, the outflow passageway 74 may be integrally formed with the outlet tube 66. The outflow passageway 74 includes a first end 78 and a second end 80, with the first end 78 being fluidly coupled to the outlet 44 and the second end 80 being fluidly coupled to the fuel pump 14. In illustrative embodiments, the second end 80 is coupled to a first intake port 82 of the fuel pump 14, as discussed below. Fuel may flow through the outflow passageway 78 by fuel pump 14, through suction.

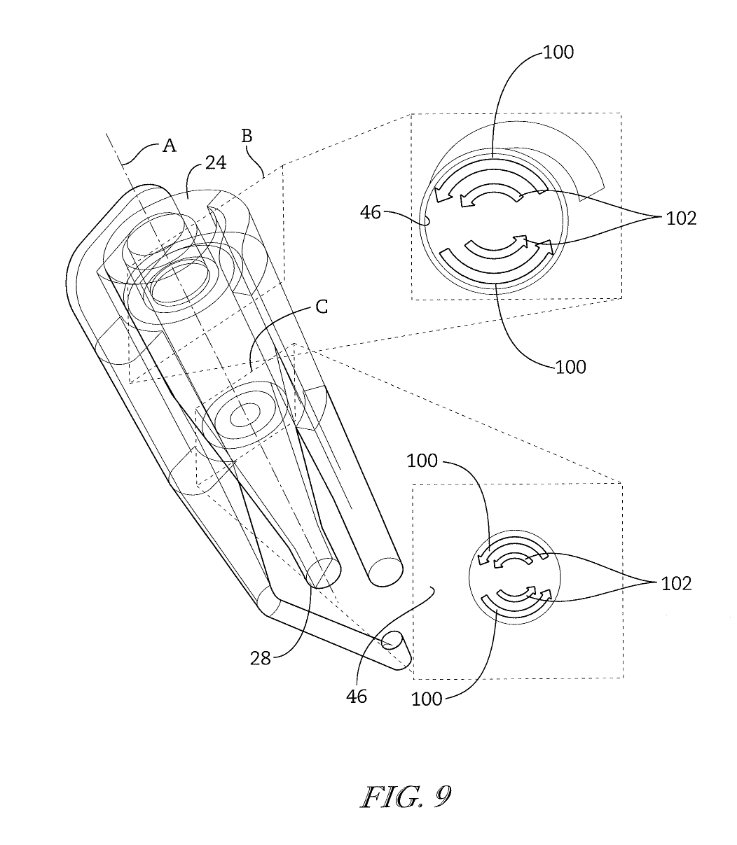

Fuel pump 14 may include a pump housing 84, a pump motor 86, the first intake port 82, a first exit port 88, a second intake port 90, and a second exit port 92, as illustrated in, for example FIG. 8. The fuel pump 14 may be configured to both pump fuel into the reservoir 12 from the fuel tank as well as pump fuel from the reservoir 12 into a passageway that can transport the fuel to the engine. The fuel pump 14 may be of various sizes or configurations, and may be generally shaped to be received in the space 18 of the reservoir 12.

Fuel pump 14 may be typically configured to receive fuel from the outflow passageway 74 through the first intake port 82. Specifically, the pump motor 86 may provide suction to the fluid flowing through the fuel pump 14 to cause fuel to flow into the fuel pump 14 via the first intake port 82. In illustrative embodiments, the suction created by fuel pump 14 causes fuel from the fuel tank to be suctioned into the cyclonic filter 20 via the inlet port 22, the fuel thereafter flowing through the cyclone separator 26 and into the outlet 44 to be carried to the fuel pump 14 via the outflow passageway 74. In illustrative embodiments, continued use of the pump motor 86 causes a continued stream of fuel to flow into the fuel pump 14 from the cyclonic filter 20. Accordingly, the outflow passageway 74 between the fuel pump 14 and cyclonic filter 20 may be a closed or pressurized system that permits the suction created by the fuel pump 14 to drive fuel into the cyclonic filter 20. In illustrative embodiments, the first intake port 82 of the fuel pump 14 may be configured adjacent a bottom side of the fuel pump 14, as illustrated in FIG. 8.

Pump motor 86 of the fuel pump 14 pumps fuel from the first intake port 82 into the space 18 of the reservoir 12 via the first exit port 88. The first exit port 88 may be located at various positions along the fuel pump 14. For example, the first exit port 88 may be positioned to be generally in linear alignment with the first intake port 82, as illustrated in FIG. 8.

Fuel pump 14 is configured to pump fuel from the reservoir 12 into an external fuel passageway connected to the engine of the vehicle. Specifically, fuel may be suctioned or pumped into the fuel pump 14 via the second intake port 90 by the pump motor 86 and may be transmitted to the external fuel passageway via the second exit port 92. As the reservoir 12 may be configured to be received within the fuel tank of the vehicle, the second exit port 92 may extend through the top end cap 21 of the reservoir 12 in order to connect with the external fuel passageway, with the top end cap 21 being positioned adjacent to the sides or top of the fuel tank. Other configurations for connecting the second exit port 92 to the external fuel passageway are known in the art. Fuel pump 14 may be used in conjunction with a venturi mechanism (not shown) that causes fuel to be suctioned into the cyclonic filter 20 as fuel flows to the engine.

The fuel pump 14 may optionally include an internal filter (not shown) that provides additional filtration of the fuel flowing through the fuel pump 14. The internal filter may filter fuel flowing from the first intake port 82 to the first exit port 88, fuel flowing from the second intake port 90 to the second exit port 92, or both. The internal filter 94 may include a paper or fibrous filter (not shown), as is known in the art.

As illustrated, for example, in FIGS. 2, 3, 6 and 8 and described herein, the present disclosure is directed to a fuel sending unit 10 that receives fuel from a fuel tank and processes the fuel in a cyclonic filter assembly 20 to remove particulate and debris from the fuel. As fuel is contained in a fuel tank, it is capable of picking up particles and other undesired contaminants from the walls or sides of the fuel tank. This is particularly true when a fuel tank corrodes and has been in service for a long time period. The cyclonic filter assembly 20 may be located within a fuel reservoir 12 that is insertable into a portion of the fuel tank. The cyclonic filter assembly 20 is configured to receive fuel from the fuel tank and separate the particles from the fuel by subjecting the fuel to a centrifugal force as it travels around an annular wall 46 of the cyclonic filter assembly 20. Due to the size and configuration of the cyclonic filter assembly 20, the particulates, which are heavier than the fuel, separate from the fuel and collide with wall 46. Due to gravitational forces, the particulates then travel down the wall 46 into a particulate storage chamber 42, where they are retained in the chamber 42 by the force of gravity. When the filtered fuel has traveled to a specific location on the annular wall of the cyclonic filter 20, the filtered fuel is rotated upward to an exit port at the top of the cyclonic filter assembly 20, where it is received by an outlet that transports the cleaned fuel away from the filter assembly 20 and to a fuel pump 14. The fuel pump 14 includes an inlet port 82 that can receive fuel from the cyclonic filter assembly 20 in closed communication with the cyclonic filter assembly 20. As the fuel pump 14 runs, it creates suction at the inlet port 82 to drive fuel from the fuel tank into the cyclonic filter assembly 20 so that it can be processed. The amount and types of particulates removed from the fuel being processed in the cyclonic filter assembly 20 is related to various parameters of the fuel system 10, including, for example, the speed of the fuel traveling through the cyclonic filter assembly 20 (via the vacuum force of the pump motor), the size and shape of the annular wall 46 of the cyclonic filter assembly 20, the amount of centrifugal force/pressure on the fuel, and/or the distance of travel of fuel between the inlet of the cyclonic filter 20 and the suction source at the fuel pump 14.

While directional terminology, such as upper, lower, top, bottom, etc. is used throughout the present application, such terminology is not intended to limit the disclosure. Such terminology is only used for purposes of describing the various features and components in relation to one another. While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of the apparatus, systems, and methods that incorporate one or more of the features of the present disclosure.

We claim:

1. An in tank fuel sending unit comprising:
a cyclonic filter assembly adapted to be positioned in a fuel tank of a vehicle, the cyclonic filter assembly including a cyclonic chamber, having an inlet opening adapted to receive unfiltered fuel, an outlet, and a particulate storage chamber, the particulate storage chamber and outlet opening being axially aligned about a first axis;
an exit passageway connected to the outlet to receive filtered fuel;
wherein the inlet opening is connected to an inlet port to transport unfiltered fuel from the inlet port into the cyclonic chamber, the cyclonic chamber including a conical portion having a first diameter adjacent the storage chamber and a second diameter positioned closer to the inlet opening, the second diameter being greater than the first diameter;
a fuel pump positioned downstream from the cyclonic filter and a fuel reservoir that houses at least a portion of the fuel pump and cyclonic filter.

2. The fuel sending unit of claim 1, wherein the conical portion is centered about the first axis.

3. The fuel sending unit of claim 2, wherein the inlet opening is tangential to the first axis.

4. The fuel sending unit of claim 1, wherein the cyclonic filter assembly includes a cylindrical portion adjacent to the conical portion, the cylindrical portion having a dimension generally equal to the second diameter of the conical portion.

5. The fuel sending unit of claim 4, wherein the inlet opening is formed within a wall of the cylindrical portion.

6. The fuel sending unit of claim 5, wherein the outlet includes an annular wall that has a diameter less than the cylindrical portion.

7. The fuel sending unit of claim 6, wherein the annular wall of the outlet extends into the cyclonic chamber.

8. The fuel sending unit of claim 5, wherein the annular wall has a third diameter greater than the first diameter but smaller than the second diameter.

9. The fuel sending unit of claim 8, wherein the annular wall of the outlet and the wall of the cylindrical portion form a fluid flow path for fluid flowing into the cyclonic chamber from the inlet opening.

10. A fuel system for a vehicle, the fuel system comprising:
a fuel tank;
a fuel sending unit configured to be received the fuel tank, the fuel sending unit comprising
a fuel reservoir;
an inlet port to receive fuel from the fuel tank;
a filter assembly formed to include a cyclone separator, the filter assembly configured to receive fuel from the inlet port and expose the fuel to centrifugal force inside the cyclone separator to separate particulate matter from the fuel;
a fuel pump configured to receive fuel from the filter assembly and pump fuel into the fuel reservoir; and
wherein the cyclonic separator includes a particulate storage chamber to store particulates removed from the fuel.

11. The fuel system of claim 10, wherein the fuel pump is further configured to pump fuel from the fuel reservoir to an external fuel pathway.

12. The fuel system of claim 10, wherein the fuel sending unit further includes an internal filter.

13. The fuel system of claim 10, wherein the cyclonic separator is coupled to the fuel pump by an enclosed passageway.

14. The fuel system of claim 13, wherein fuel is transported to the filter assembly through a vacuum created in the fuel pump.

15. The fuel system of claim 14, where fuel enters the inlet port by the force of the vacuum created in the fuel pump.

16. The fuel system of claim 10, where fuel enters the filter assembly in a direction tangential to an axis of rotation of fuel in the cyclonic filter assembly.

17. The fuel system of claim 16, wherein the fuel leaves the filter assembly at an outlet positioned circumferentially about an axis of rotation of the fuel exposed to centrifugal force inside the cyclone chamber.

18. A method for filtering fuel for a vehicle, the method comprising:
transferring fuel from a fuel tank to an inlet opening of a cyclonic filter assembly;
subjecting the fuel to centrifugal force by rotating the fuel about an axis in a first flow direction along a wall of the cyclonic filter assembly to cause a first vortex;
separating one or more particulates from the fuel through the application of centrifugal force;
collecting the particulates in a particulate storage chamber located at a first end of the cyclonic filter assembly; and
causing the filtered fuel to change direction of flow and to rotate about the axis in a second vortex radially inward of the first vortex, wherein the filtered fuel is directed to an outlet located at a second end of the cyclonic filter assembly.

19. The method of claim 18, further comprising:
applying a suction to the cyclonic filter assembly to cause the fuel to be transferred to the inlet opening of the cyclonic filter assembly and rotated within the cyclonic filter assembly.

20. The method of claim 19, wherein the suction is supplied to the cyclonic filter assembly via a fuel pump coupled to the outlet.
